(19) United States
(12) Patent Application Publication
(10) Pub. No.: US 2016/0255444 A1
(43) Pub. Date: Sep. 1, 2016

(54) AUTOMATED DIRECTIONAL MICROPHONE FOR HEARING AID COMPANION MICROPHONE

(71) Applicant: Starkey Laboratories, Inc., Eden Prairie, MN (US)

(72) Inventors: Joe Bange, Eden Prairie, MN (US); Thomas Howard Burns, St. Louis Park, MN (US)

(21) Appl. No.: 14/634,123

(22) Filed: Feb. 27, 2015

(51) Int. Cl. H04R 25/00; H04R 5/027

(52) U.S. Cl. CPC H04R 25/405; H04R 25/407; H04R 25/43; H04R 25/554; H04R 5/027

(57) ABSTRACT

A hearing aid system is described that includes a hearing aid and a companion microphone, separate from the hearing aid itself, for improving the understanding of speech spoken by a particular person or produced by a particular sound source. Also described are techniques for dealing with the problem of how to make a robust directional microphone that requires no user input as to the orientation of the companion microphone.

### FIELD OF THE INVENTION

This invention pertains to electronic hearing aids, hearing aid systems, and methods for their use.

### BACKGROUND

Hearing aids are electronic instruments that compensate for hearing losses by amplifying sound. The electronic components of a hearing aid may include a microphone for receiving ambient sound, processing circuitry for amplifying the microphone signal in a manner that depends upon the frequency and amplitude of the microphone signal, a speaker for converting the amplified microphone signal to sound for the wearer, and a battery for powering the components. Because a hearing aid microphone typically picks up sound from all directions, wearers may still have difficulty understanding the speech of a person speaking to the wearer.

### BRIEF DESCRIPTION OF THE DRAWINGS

FIGS. 1A and 1B show the basic electronic components of an example hearing aid and companion microphone.

FIG. 2 illustrates an example microphone array made up of two omnidirectional microphones whose individual outputs may processed to produce a desired directional polar pattern.

FIG. 3 shows examples of polar patterns that can be produced by a two-microphone array.

FIG. 4 shows an example array of three omni-directional microphones arranged in an equilateral triangle.

FIG. 5 shows and example of cardioids that may be produced by a three-microphone array.

FIG. 6 shows and example of cardioids that may be produced by a three-microphone array.

### DETAILED DESCRIPTION

A hearing aid may incorporate a companion microphone, separate from the hearing aid itself, for improving the understanding of speech spoken by a particular person or produced by a particular sound source. The companion microphone is a hearing aid accessory device that is designed to be worn by a companion of the hearing aid user and not by the hearing aid wearer. In one example embodiment, the companion microphone is worn in the upper torso area by the companion speaker in relatively close proximity to the mouth. The companion microphone then captures the voice of the companion speaker and sends the voice information to the hearing aid wirelessly. Ideally, the companion microphone would have a directional polar pattern directed toward the speaker's mouth.

Described herein are techniques for dealing with the problem of how to make a robust directional microphone that requires no user input as to the orientation of the companion microphone. The companion user may then clip the companion microphone anywhere to his/her clothing in any direction and still get the full benefit of a directional microphone pointed up towards the companion user's mouth. This also allows for a simple, light-weight, user-friendly, and ergonomically pleasing solution for a clip that attaches the companion microphone to clothing. In an example embodiment as described below, the companion microphone incorporates processing circuitry that is configured to select an optimal endfire directional array based on an accelerometer input to point the directional microphone up and therefore toward the companion user's mouth.

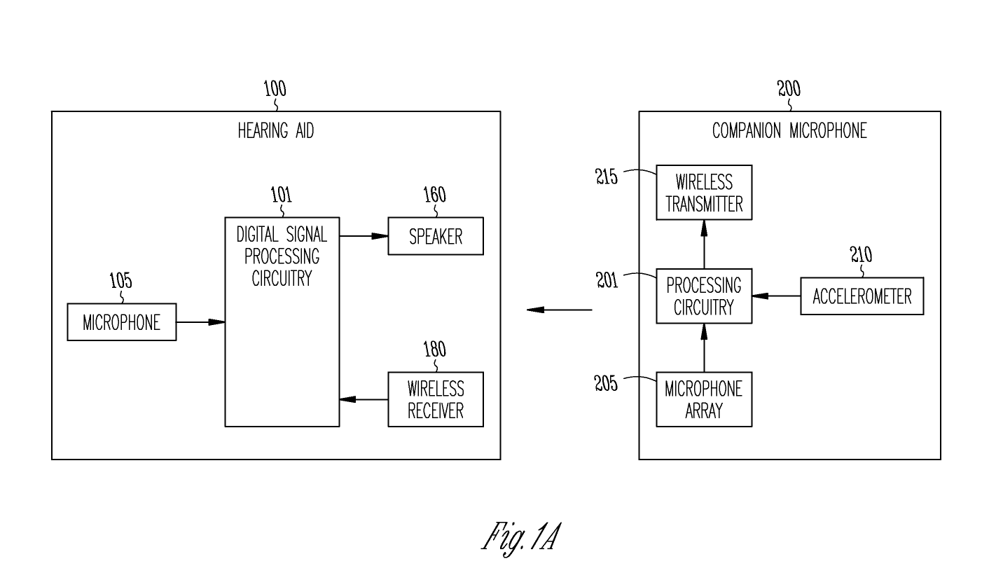

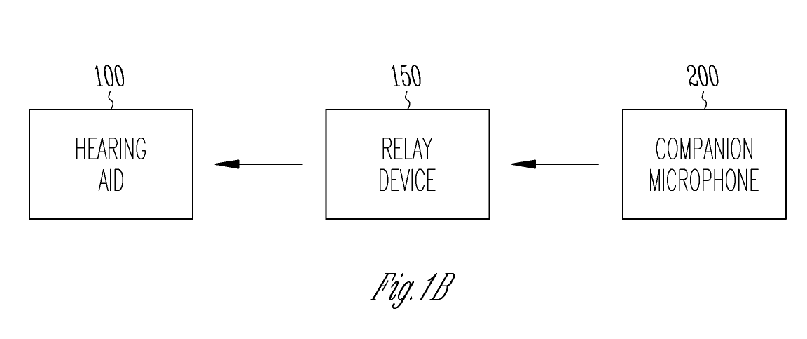

FIG. 1A illustrates the basic functional components of an example hearing aid 100. The electronic circuitry of the hearing aid is contained within a housing that may be placed, for example, in the external ear canal or behind the ear. A microphone 105 receives sound waves from the environment and converts the sound into an input signal. The input signal is then amplified by pre-amplifier and sampled and digitized by an A/D converter to result in a digitized input signal. The device's digital signal processing (DSP) circuitry 101 processes the digitized input signal into an output signal in a manner that compensates for the patient's hearing deficit. The digital processing circuitry 101 may be implemented in a variety of different ways, such as with an integrated digital signal processor or with a mixture of discrete analog and digital components that include a processor executing programmed instructions contained in a processor-readable storage medium. The output signal is then passed to an audio output stage that drives speaker 160 (also referred to as a receiver) to convert the output signal into an audio output. Also shown in FIG. 1A is a wireless receiver 180 interfaced to the hearing aid's DSP circuitry and a companion microphone 200 that wirelessly transmits audio signals picked up by the companion microphone to the wireless receiver 180. The wireless receiver 180 then produces a second input signal for the DSP circuitry that may be combined with the input signal produced by the microphone 105 or used in place thereof.

One of the challenges in the design of a companion microphone is that there are various body shapes, clothing options, and clip locations for the companion microphone that must be accommodated while ideally maintaining a directional microphone pointed towards the speaker's mouth. As shown in FIG. 1A, in one embodiment, the companion microphone 200 comprises a microphone array 205, processing circuitry 201, an accelerometer 210, and a wireless transmitter 215 for transmitting the audio picked up by the microphone array to the wireless receiver 180 of the hearing aid. As described below, the processing circuitry 201 may include signal processing elements and switching circuitry for combining the outputs produced by the individual microphones of the microphone array 205 in a manner that results in a polar pattern that is directed toward the mouth of the companion speaker even when the individual microphones have an omnidirectional polar pattern. The accelerometer 210 senses the gravitational direction and provides an input to the processing circuitry 201 that indicates which direction is up relative to the orientation of the companion microphone. In this way, even as the companion microphone is arbitrarily oriented by its wearer, the processing circuitry 201 may adjust the directionality of the microphone array 205 to point upward and toward the wearer's mouth. Such a directional polar pattern for the companion microphone lessens the picking up of ambient sound and improves the quality of the speech signal transmitted to the hearing aid.

In the system illustrated in FIG. 1A, communication between the hearing aid 100 and the companion microphone 200 may be implemented by wireless transmitter 215 and wireless receiver 180 as a near-field magnetic induction (NFMI) link or as a far-field RF (radio-frequency) link. In another embodiment as illustrated by FIG. 1B, a relay device 150 worn by the user may be used to transceive between the hearing aid 100 and companion microphone 200. For example, the relay device 150 may communicate with hearing aid 100 via an NFMI link and communicate with the companion microphone 200 via a far-field RF link (e.g., using a standard RF communications protocol such as Bluetooth). The relay device in that embodiment could include an RF receiver for receiving signals from the companion microphone 200 and a neck loop for transmitting NFMI signals to a telecoil in the hearing aid.

The above descriptions have been with reference to a companion microphone 200 that communicates with a single hearing aid 100. It should be appreciated, however, that the companion microphone 200 would typically communicate with a pair of hearing aids 100 worn by the user.

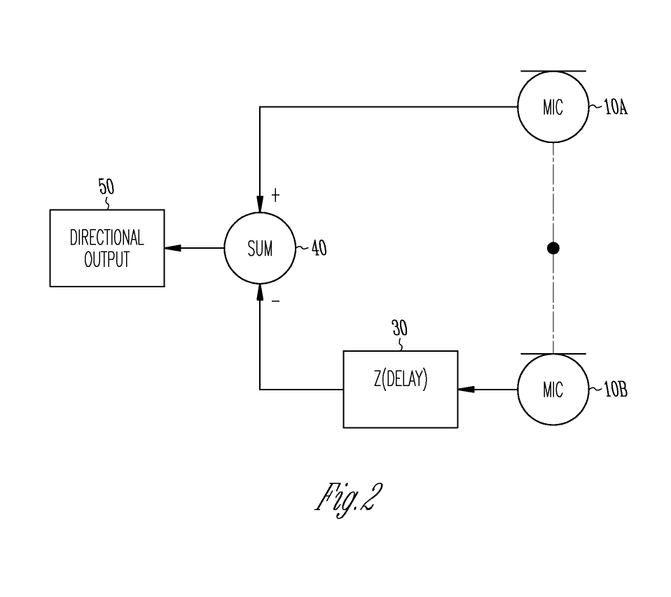

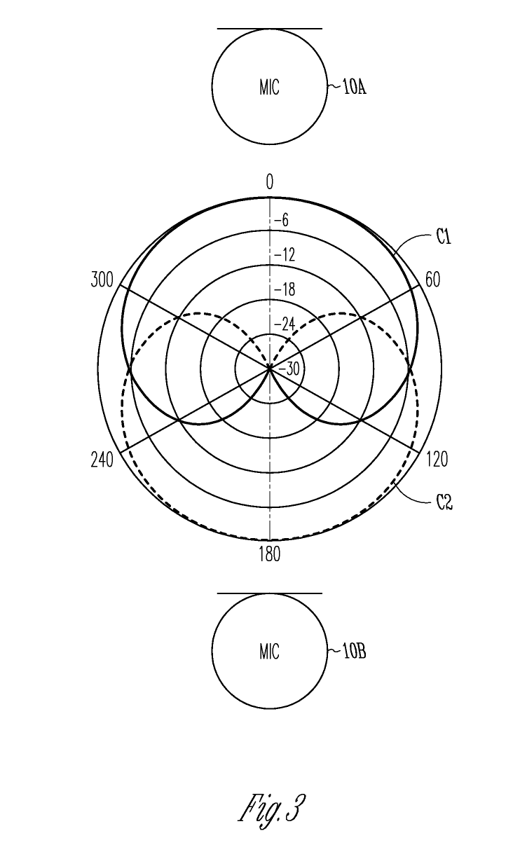

A microphone's directionality or polar pattern indicates how sensitive it is to sounds arriving at different angles about its central axis. An omnidirectional microphone, for example, has a polar pattern that is approximately spherical in shape. In the case of a microphone array that includes a plurality of microphones, the polar pattern of the microphone array may be altered by summing and delaying operations applied to the outputs of the microphones making up the array. FIG. 2 illustrates an example microphone array made up of omnidirectional microphones 10a and 10b whose individual outputs may delayed by a delay element 30 and summed by summer 40 to result in a directional output 50. Delaying and summing microphone outputs may be used to alter the directionality of a microphone array based upon the different arrival times at the microphones 10a and 10b of sound emitted from a single source due to path differences. FIG. 3 shows an example of polar patterns C1 and C2 (cardioids in this example) produced by microphones 10a and 10b when different amounts of time delay are applied via delay element 30. For those skilled in the art of endfire processing techniques, different parameters of microphone spacing and delay would vary the shape of the polar pattern.

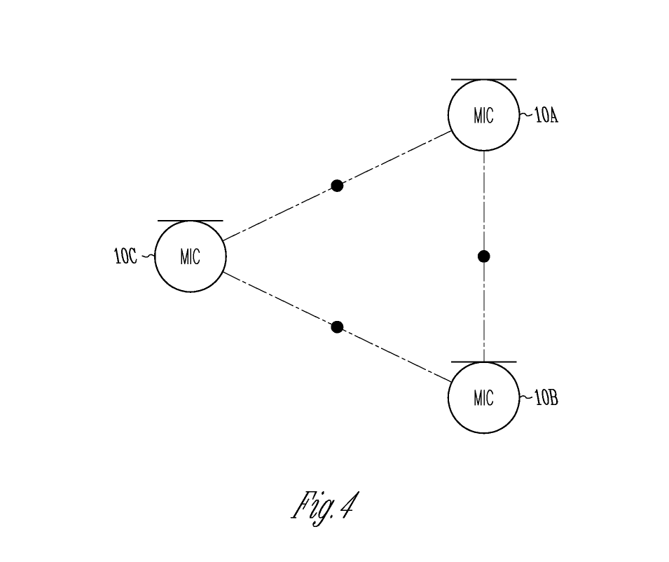

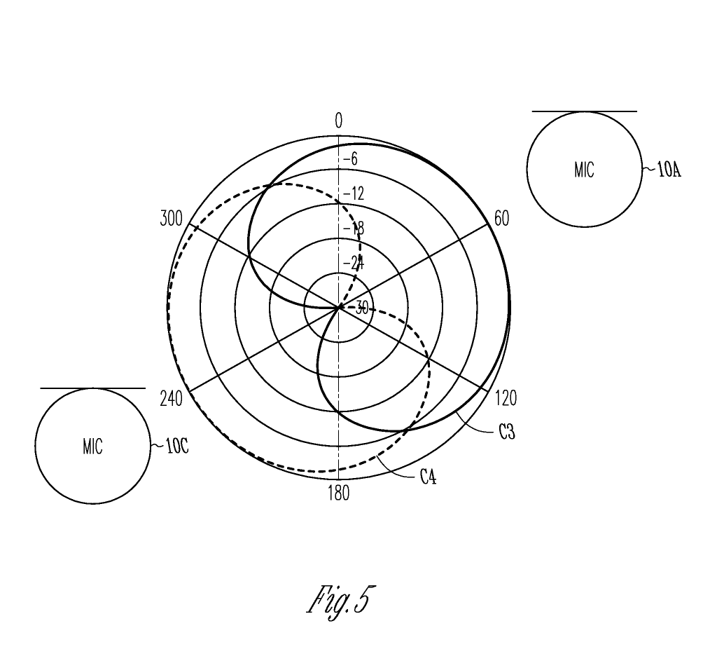

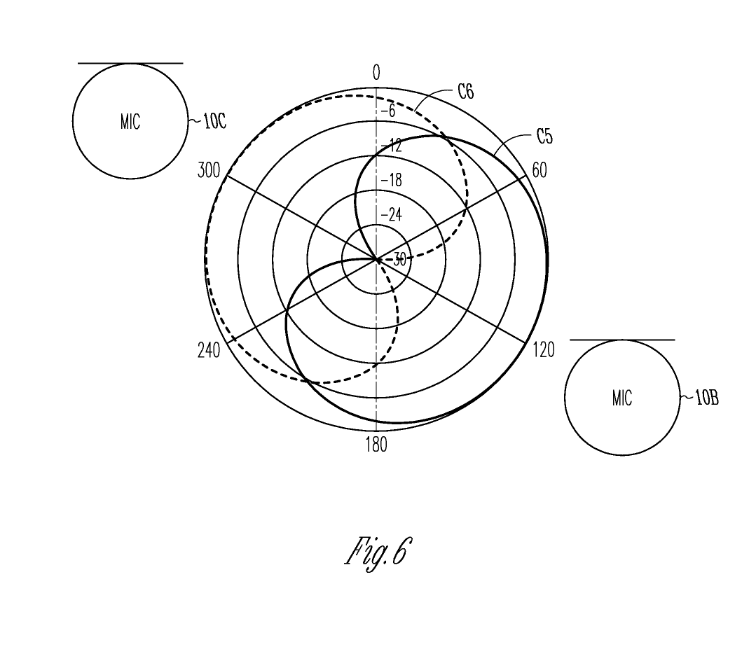

FIG. 4 shows an example configuration of omnidirectional microphones 10a and 10b as shown in FIG. 2 to which has been added an additional microphone 10c. By selecting different pairs of microphones and applying different time delays, different polar patterns may be produced. FIG. 5 shows an example of polar patterns C3 and C4 that may be produced by selecting microphones 10a and 10c and applying different time delays. FIG. 6 shows an example of polar patterns C5 and C6 that may be produced by selecting microphones 10a and 10c and applying different time delays. FIGS. 3, 5, and 6 thus show three pairs of cardioids that may be produced by the microphone configuration of FIG. 4 by selecting different microphone pairs and where the particular one of the pair of cardioids that is produced depends upon the amount of time delay that is applied. In proceeding through the polar patterns of FIGS. 3, 5, and 6, each pair of cardioids is rotated 60° from the previous pair of cardioids. When any of the three pairs of freefield cardioids is chosen by the logic from the accelerometer, the minimum angles of sensitivity (30°+n60° where 1<n<5) are merely 2.4 dB less than the maximum angles of sensitivity (0° +n60° where 1<n<5). As a result, the system has the ability to steer the primary lobe and sense the sound from the wearer's mouth at any angle with only 2.4 dB worst-case reduction in level.

In one embodiment, three omnidirectional microphones of a microphone array in the companion microphone are arranged in an equilateral triangle. The microphones may be arranged in pairs in order to create a cardioid directional microphone using endfire processing techniques. With the three microphones, a total of six cardioid directional microphone can be computed each spaced 60° apart. To choose the optimal one of the six directional microphone directions, the accelerometer is used to determine which direction is “up”. Since the companion microphone is typically worn on the upper torso, “up” is the direction of the wearer's mouth. With the angle of the accelerometer that is pointing up determined by signals from the accelerometer, the processing circuitry of companion microphone may then select the one one of the six possible microphone directionalities that most nearly matches the upward direction for use.

In an embodiment with a three-microphone array in the companion microphone described above, the processing circuitry 201 of the companion microphone selects a pair of microphones from the three microphones in the microphone array and adjusts the time delay applied to one of microphones in the pair to achieve a directional polar pattern that most nearly matches the upward direction as indicated by signals from the accelerometer. In other embodiments, the microphone array may include four or more microphones and the directional polar pattern produced by selecting particular microphones from the array and applying time delays may vary in three-dimensions. Also, in other embodiments, the processing circuity 201 may select more than two microphones from the microphone array and apply appropriate time delays to the selected microphones in order to produce the desired directional polar pattern.

### EXAMPLE EMBODIMENTS

In Example 1, a hearing assistance system, comprises: a hearing aid for wearing by a hearing aid user and a companion microphone for wearing by a companion user; wherein the hearing aid comprises a microphone for converting an audio input into a first input signal, a wireless receiver for receiving a wireless signal to be used as a second input signal, a digital signal processor for processing the first input signal and the second input signal to produce an output signal in a manner that compensates for the patient's hearing deficit, and a speaker for converting the output signal into an audio output; wherein the companion microphone comprises a microphone array that includes a plurality of microphones, processing circuitry for configuring the microphone array to produce the second input signal, a wireless transmitter for transmitting the second input signal to the wireless receiver of the hearing aid, and an accelerometer; and, wherein the processing circuitry of the companion microphone is configured to configure the microphone array to have a polar pattern with a directionality pointed upward as indicated by signals received from the accelerometer. The processing circuitry of the companion microphone may include switching circuitry for selecting particular microphones from the array for use in producing the desired directional polar pattern. The accelerometer may be a three-axis accelerometer that outputs signals indicating which direction is up. The processing circuitry of the companion microphone may configure the microphone array to produce a directional polar pattern that most nearly matches the upward direction as indicated by the accelerometer signal. The microphones included in the microphone array may omnidirectional microphones. The microphone array may include three microphones arranged as an equilateral triangle. The processing circuitry of companion microphone may include delay and summing elements for configuring the directionality of the microphone array. The microphone array may include four or more microphones, and the processing circuitry of the companion microphone may be configured to configure the directionality of the microphone array in three dimensions in accordance with signals received from the accelerometer. The DSP of the hearing aid may be configured to add the first and second input signals to produce an output signal. The DSP of the hearing aid may be configured to disable the first input signal and use the second input signal to produce an output signal. The polar pattern of the microphone array may be a cardioid shape. The processing circuitry of the companion microphone may be configured to adjust the directionality of the microphone array at periodic intervals in accordance with signals received from the accelerometer. The processing circuitry of the companion microphone may be configured to adjust the directionality of the microphone array in accordance with signals received from the accelerometer in response to a user input.

In Example 2, a companion microphone for use in conjunction with a hearing aid, comprises: a microphone array that includes a plurality of microphones; processing circuitry for configuring the microphone array to produce an input signal; a wireless transmitter for transmitting the input signal to a wireless receiver of the hearing aid; an accelerometer; and, wherein the processing circuitry of the companion microphone is configured to configure the microphone array to have a polar pattern with a directionality pointed upward as indicated by signals received from the accelerometer. The companion microphone may incorporate any the features described above for Example 1.

In Example 3, a method for operating a hearing aid system, comprises: operating a hearing aid to convert an audio input into a first input signal, receiving a wireless signal to be used as a second input signal, processing the first input signal and the second input signal to produce an output signal in a manner that compensates for the patient's hearing deficit, and a converting the output signal into an audio output; operating a companion microphone that comprises a microphone array that includes a plurality of microphones by configuring the microphone array to produce the second input signal, and transmitting the second input signal to a wireless receiver of the hearing aid; and, configuring the microphone array to have a polar pattern with a directionality pointed upward as indicated by signals received from an accelerometer. The method may also include any of the features described above for Example 1.

It is understood that digital hearing aids include a processor. In digital hearing aids with a processor, programmable gains may be employed to adjust the hearing aid output to a wearer's particular hearing impairment. The processor may be a digital signal processor (DSP), microprocessor, microcontroller, other digital logic, or combinations thereof. The processing may be done by a single processor, or may be distributed over different devices. The processing of signals referenced in this application can be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, buffering, and certain types of filtering and processing. In various embodiments the processor is adapted to perform instructions stored in one or more memories, which may or may not be explicitly shown. Various types of memory may be used, including volatile and nonvolatile forms of memory. In various embodiments, the processor or other processing devices execute instructions to perform a number of signal processing tasks. Such embodiments may include analog components in communication with the processor to perform signal processing tasks, such as sound reception by a microphone, or playing of sound using a receiver (i.e., in applications where such transducers are used). In various embodiments, different realizations of the block diagrams, circuits, and processes set forth herein can be created by one of skill in the art without departing from the scope of the present subject matter.

It is further understood that different hearing assistance devices may embody the present subject matter without departing from the scope of the present disclosure. The devices depicted in the figures are intended to demonstrate the subject matter, but not necessarily in a limited, exhaustive, or exclusive sense. It is also understood that the present subject matter can be used with a device designed for use in the right ear or the left ear or both ears of the wearer.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A hearing assistance system, comprising:
a hearing aid for wearing by a hearing aid user and a companion microphone for wearing by a companion user;
wherein the hearing aid comprises a microphone for converting an audio input into a first input signal, a wireless receiver for receiving a wireless signal to be used as a second input signal, a digital signal processor for processing the first input signal and the second input signal to produce an output signal in a manner that compensates for the patient's hearing deficit, and a speaker for converting the output signal into an audio output;
wherein the companion microphone comprises a microphone array that includes a plurality of microphones, processing circuitry for configuring the microphone array to produce the second input signal, a wireless transmitter for transmitting the second input signal to the wireless receiver of the hearing aid, and an accelerometer; and,
wherein the processing circuitry of the companion microphone is configured to configure the microphone array to have a polar pattern with a directionality pointed upward as indicated by signals received from the accelerometer.

2. The hearing aid system of claim 1 wherein the microphones included in the microphone array are omnidirectional microphones.

3. The hearing aid system of claim 1 wherein the microphone array includes three microphones arranged as an equilateral triangle.

4. The hearing aid system of claim 1 wherein the processing circuitry of companion microphone includes delay and summing elements for configuring the directionality of the microphone array.

5. The hearing aid system of claim 1 wherein the microphone array includes four or more microphones and wherein the processing circuitry of the companion microphone is configured to configure the directionality of the microphone array in three dimensions in accordance with signals received from the accelerometer.

6. The hearing aid system of claim 1 wherein the DSP of the hearing aid is configured to add the first and second input signals to produce an output signal.

7. The hearing aid system of claim 1 wherein the DSP of the hearing aid is configured to disable the first input signal and use the second input signal to produce an output signal.

8. The hearing aid system of claim 1 wherein the polar pattern of the microphone array is a cardioid shape.

9. The hearing aid system of claim 1 wherein the processing circuitry of the companion microphone is configured to adjust the directionality of the microphone array at periodic intervals in accordance with signals received from the accelerometer.

10. The hearing aid system of claim 1 wherein the processing circuitry of the companion microphone is configured to adjust the directionality of the microphone array in accordance with signals received from the accelerometer in response to a user input.

11. A companion microphone for use in conjunction with a hearing aid, comprising:
a microphone array that includes a plurality of microphones;
processing circuitry for configuring the microphone array to produce an input signal;
a wireless transmitter for transmitting the input signal to a wireless receiver of the hearing aid;
an accelerometer; and,
wherein the processing circuitry of the companion microphone is configured to configure the microphone array to have a polar pattern with a directionality pointed upward as indicated by signals received from the accelerometer.

12. The companion microphone of claim 11 wherein the microphones included in the microphone array are omnidirectional microphones.

13. The companion microphone of claim 11 wherein the microphone array includes three microphones arranged as an equilateral triangle.

14. The companion microphone of claim 11 wherein the processing circuitry includes delay and summing elements for configuring the directionality of the microphone array.

15. The companion microphone of claim 11 wherein the microphone array includes four or more microphones and wherein the processing circuitry is configured to configure the directionality of the microphone array in three dimensions in accordance with signals received from the accelerometer.

16. A method for operating a hearing aid system, comprising:
operating a hearing aid to convert an audio input into a first input signal, receiving a wireless signal to be used as a second input signal, processing the first input signal and the second input signal to produce an output signal in a manner that compensates for the patient's hearing deficit, and a converting the output signal into an audio output;
operating a companion microphone that comprises a microphone array that includes a plurality of microphones by configuring the microphone array to produce the second input signal, and transmitting the second input signal to a wireless receiver of the hearing aid; and,
configuring the microphone array to have a polar pattern with a directionality pointed upward as indicated by signals received from an accelerometer.

17. The method of claim 16 further comprising delaying and summing outputs of the plurality of microphones in order to configure the directionality of the microphone array.

18. The method of claim 16 further comprising operating the hearing aid to add the first and second input signals to produce an output signal.

19. The method of claim 16 further comprising operating the hearing aid to disable the first input signal and use the second input signal to produce an output signal.

20. The method of claim 16 wherein the microphone array includes three microphones arranged as an equilateral triangle.
